(19) United States
(12) Patent Application Publication
(10) Pub. No.: US 2013/0324792 A1
(43) Pub. Date: Dec. 5, 2013

(54) TARGETED LUBRICANT DELIVERY DEVICE

(71) Applicants: Jack Mizrahi, Dollard des Ormeaux (CA); Fran Derkson, Dollard des Ormeaux (CA)

(72) Inventors: Jack Mizrahi, Dollard des Ormeaux (CA); Fran Derkson, Dollard des Ormeaux (CA)

(73) Assignee: EUPHORIC PRODUCTS D & M INC., Dollard des Ormeaux (CA)

(21) Appl. No.: 13/484,377

(22) Filed: May 31, 2012

(51) Int. Cl. A61H 19/00

(52) U.S. Cl. 600/38

(57) ABSTRACT

It has been discovered that a multi-use dildo with a single use lubricant cartridge having innovative dispensing means provides a hygienic and pleasurable way of administering lubricant to a body orifice during sexual/masturbatory activity. Furthermore, design of the lubricant cartridge prevents the lubricant from entering the delivery channel, thereby reducing the cleaning requirements for the internal, hard to clean areas of the device. Further advantages of the device are that it dispenses a manually controlled amount of lubricant and its length is optimized to deliver lubricant higher up into the vaginal tract where it will offer best lubrication for immediate alleviation of vaginal dryness and allow pleasurable sexual intercourse. The device also comprises an internal easy glide sleeve for easy insertion and removal of single-use lubricant cartridges.

### TECHNICAL FIELD

This invention relates generally to lubricant delivery devices. More specifically, this invention relates to a penile-shaped device for targeted and hygienic delivery of lubricant to a body orifice.

### BACKGROUND

As a result of this vaginal dryness, forceful penetration may rip or tear the vaginal walls, causing bleeding, extreme pain and discomfort, leaving women with little or no desire to have sexual intercourse.

Vaginal atrophy is a frequent complaint of postmenopausal women; symptoms of vaginal atrophy include vaginal dryness, itching, discomfort and painful intercourse. Systemic treatment for these symptoms in the form of oral hormone replacement therapy is available but not always necessary. Vaginal atrophy can be treated with less side-effects using targeted lubricant delivery.

The number of women reporting vaginal dryness varies according to age and other factors. However, 1 in 3 women will experience dryness at some time in their life. It is more common in older women, especially after menopause when half of all women will report problems, increasing to 2 out of 3 women over the age of 65. It is a difficult subject for most women to talk about and only about a quarter of post-menopausal women, with serious discomfort, will ever ask a doctor or nurse for help.

A brief description of the condition known as vaginal dryness proposed by the Mayo Clinic states: <<Vaginal dryness is a common problem for women during and after menopause, although inadequate vaginal lubrication can occur at any age. Vaginal dryness is a hallmark sign of vaginal atrophy (atrophic vaginitis)—thinning and inflammation of the vaginal walls due to a decline in estrogen. Along with vaginal dryness, you might also have itching and stinging around the vaginal opening and in the lower third of the vagina. Vaginal dryness can make intercourse uncomfortable. Most vaginal lubrication consists of clear fluid that seeps through the walls of the blood vessels encircling the vagina. Upon sexual arousal, more blood flows to the pelvic organs, creating more lubricating vaginal fluid. However, the hormonal changes of menopause, childbirth and breast-feeding may disrupt this process.

Use of intimate moisturisers also varies greatly from country to country, with only about 1 in 20 women currently using them, although it is suggested that perhaps 1 in 3 women would be interested in doing so. Dryness is most noticeable during sexual intercourse, but a lot of women notice accompanying soreness, burning or itching and a general discomfort of the intimate area caused by chafing.

A variety of conditions can cause vaginal dryness: Decreased oestrogen levels are the main cause. Oestrogen is the main female hormone that helps keep vaginal tissue healthy by maintaining normal vaginal lubrication, tissue elasticity and acidity. These factors create a natural defence against vaginal and urinary tract infections. Oestrogen levels can fall for a number of reasons:
a. Menopause or around the menopause;
b. Childbirth;
c. Breast-feeding;
d. Effects of radiation therapy, hormone therapy and chemotherapy on the ovaries;
e. Surgical removal of ovaries;
f. Exercise;
g. Severe weight loss, or being underweight ;
h. Immune disorders;
i. Cigarette smoking;
j. Medication: Allergy and cold medications, as well as some antidepressants, can decrease the moisture in many parts of your body, including the vagina. Anti-estrogen medications, such as those used to treat breast cancer, also can result in vaginal dryness.

In US Pat. Application No. 2004/0127766, Chen teaches a lubricating dildo with a pump and a motor. The dildo has pleats at a proximal end that, when pushed, actuate the motor and causes the pump to release lubricating oil at a distal end. This device requires many mechanical parts and is rather complex and expensive to manufacture.

Washington (U.S. Pat. No. 7,163,508) teaches a lubricating sexual aid comprising a shaft with a throughbore extending through it for receiving a lubricant. The device also has a head that is removably connected to the shaft as well a dispensing means, such as a plunger, for dispensing the lubricant. After using the Washington device, the head can be separated from the shaft to facilitate cleaning the inside of the device, especially the much narrower “egress aperture” of the head portion. A major drawback of the present invention is the need to thoroughly wash the inside of the device after use. On one hand, if the “reservoir” is completely filled with lubricant, the inside of the device cannot be washed without wasting lubricant until the reservoir is completely empty. On the other hand, if the reservoir is filled with only enough lubricant for a single use, the inside of the device must nevertheless be cleaned each time, lest the residual lubricant will contaminate or harden on the inside of the device.

Due to the drawbacks of the prior art, it was highly desirable to develop a device and method for targeted delivery of lubricant that are both easy to use and wash as well as being inexpensive and easy to manufacture.

### SUMMARY

It has been discovered that a multi-use dildo with a single use lubricant cartridge having innovative dispensing means provides a hygienic and pleasurable way of administering lubricant to a body orifice during sexual/masturbatory activity. Furthermore, design of the lubricant cartridge prevents the lubricant from entering the delivery channel, thereby reducing the cleaning requirements for the internal, hard to clean areas of the device. Further advantages of the device are that it dispenses a manually controlled amount of lubricant and its length is optimized to deliver lubricant higher up into the vaginal tract where it will offer best lubrication for immediate alleviation of vaginal dryness and provide for pleasurable sexual intercourse. The device also comprises an internal easy glide sleeve for easy insertion and removal of single-use lubricant cartridges.

It is therefore an object of an embodiment of the present invention to provide a device for targeted delivery of a lubricant to an orifice comprising a penile-shaped member comprising a shaft at a proximal end and a head at a distal end, the penile-shaped member further comprising a conduit therethrough from a proximal end aperture to a distal end aperture, a sealed cartridge containing the lubricant for removably inserting in the conduit; wherein the distal end of the cartridge is configured to mate with the conduit until the distal end aperture to prevent the lubricant from entering the conduit during use; and a dispensing member for delivering the lubricant to the orifice.

In some embodiments, the dispensing member further comprises an air-filled appendage fastened to or extending from the proximal end, and wherein an inside of the appendage is or becomes in fluid communication with the cartridge for dispensing the lubricant upon compressing the appendage. The appendage can be configured to have a scrotum-like appearance.

In some embodiment, the cartridge seal comprises one of a snap-off seal, a pull-off tab, a removable cap, a screw cap, a one-way valve and a check valve.

In other embodiments, the penile-shaped member is made of foam latex and further comprises two or more stiffening rods to impart a certain rigidity to the member. The lubricant reservoir of the cartridge contains a rigid delivery channel and a non-rigid reservoir pouch that can be squeezed at a proximal end of the shaft to expel the lubricant from the distal end aperture.

It is therefore another object of an embodiment of the present invention to provide a device for targeted delivery of a lubricant to a body orifice comprising a penile-shaped member comprising a shaft at a proximal end and a head at a distal end, the penile-shaped member further comprising a conduit therethrough from a proximal end aperture to a distal end aperture; a sleeve having an outer surface configured to securely mate with the conduit and a low-friction inner surface for receiving and removing a replaceable cartridge, the sleeve comprising a reservoir portion for receiving a reservoir of the cartridge located generally in a shaft portion of the device and a delivery channel portion for receiving a delivery channel of the cartridge located generally in a head portion of the device.

In some embodiments, the sealed cartridge contains the lubricant for removably inserting in the conduit; wherein the distal end of the cartridge is configured to mate with the conduit until a distal end of the conduit to prevent the lubricant from entering the conduit during use; and

It is yet another object of an embodiment of the present invention to provide a sealed cartridge containing a lubricant for use in a penile-shaped device for targeted delivery of the lubricant to a body orifice wherein the cartridge comprises a delivery channel and a reservoir and is configured to mate with a low friction sleeve inside the device and be secured to the device.

It is yet another object of an embodiment of the present invention to provide a kit for targeted delivery of a lubricant to an orifice comprising: a penile-shaped member comprising a shaft at a proximal end and a head at a distal end, the penile-shaped member further comprising a conduit therethrough from a proximal end aperture to a distal end aperture; a sleeve having an outer surface configured to securely mate with the conduit and a low-friction inner surface for receiving and removing a replaceable cartridge, the sleeve comprising a reservoir portion located at or near the proximal end and a delivery channel located at or near the distal end; a sealed cartridge containing the lubricant for removably inserting in the conduit; wherein the distal end of the cartridge is configured to mate with the conduit until the distal end aperture of the conduit to prevent the lubricant from entering the conduit during use; and a dispensing member for delivering the lubricant to the orifice.

It is yet another object of the present invention to provide a method for targeted lubricant delivery to an orifice comprising providing a penile-shaped device comprising a shaft at a proximal end and a head at a distal end, the penile-shaped member further comprising a conduit therethrough from the proximal end to an aperture at the distal end; inserting a sealed cartridge containing the lubricant in the conduit; wherein the distal end of the cartridge is configured to mate with the conduit until a distal end of the conduit to prevent the lubricant from entering the conduit during use; and dispensing the lubricant to the orifice by actuating a dispensing member.

In some embodiments, the method further comprises removing the cartridge and then washing an outside of the device.

### BRIEF DESCRIPTION OF THE DRAWINGS

The invention will be better understood by way of the following detailed description of embodiments of the invention with reference to the appended drawings, in which:

FIG. 1 shows a cross-sectional schematic representation of an embodiment of the targeted lubricant delivery device of the present invention.

FIG. 2 shows a cross-sectional schematic representation of a penile-shaped member according to an embodiment of the present invention.

FIG. 3 shows a cross-sectional schematic representation of a cartridge portion and the dispensing member portion according to an embodiment of the present invention. FIG. 3A shows a cartridge in combination with a dispensing member while FIG. 3B shows the dispensing member and cartridge separately.

FIG. 4 shows a cross-sectional schematic representation of a sleeve portion according to an embodiment of the present invention.

FIG. 5 shows an exploded cross-sectional view of a cartridge portion according to an embodiment of the present invention.

FIG. 6 shows a side view of a dispensing member according to another embodiment of the present invention.

FIG. 7 shows a side view of a dispensing member according to another embodiment of the present invention.

FIG. 8 shows a side view of a dispensing member according to yet another embodiment of the present invention.

FIG. 9A shows a cross-sectional schematic representation of a lubricant delivery device having a squeeze dispensing member and one-way valve at the distal end aperture according to an embodiment of the present invention. FIG. 9B is a bottom cross-sectional view taken at the dotted line of FIG. 9A.

### DETAILED DESCRIPTION

The device of the present invention mates functionality and sensuality whilst addressing and attending to the condition of vaginal dryness. Indeed, Applicants device addresses the condition of vaginal dryness using an innovative design that encompasses and addresses the condition of vaginal dryness all in the same veil of intimacy.

The device consists of a sealed plastic cartridge prefilled with vaginal lubricant, encased in a latex covering molded into a penile shape. The tip and/or head of the penis has a hole that meets the tip of the plastic syringe which has on the tip a blister seal.

Once the user is ready for sexual activity (in the case of the female having some degree of vaginal dryness), and/or the user is ready for masturbatory stimuli; the user applies slight downward pressure on the end of the plunger, thus breaking the blister seal and releasing the prefilled lubricant onto the tip of the latex shaped penis. Now lubricated, the latex covered apparatus can be inserted into the vaginal tubular tract where the user can dispense the desired amount of lubricant. The latex penile-shaped delivery device acts as both a dispenser of lubricant as well an inner applicator of lubricant.

Based on the symptoms of pen-menopause, menopause, and post-menopause, and addressing one of the most common menopausal symptoms, Applicants invented a product that alleviates/eliminates a woman's feelings of inadequacy and guilt with her partner, as vaginal dryness results in a lack of desire to have sexual intercourse due to the pain associated with penetration due to the lubrication within the vaginal walls.

The device comprises a prefilled cartridge (prefilled with vaginal lubricant) encased in latex (or other appropriate material) in the shape of a male penis. The device is designed to deliver various but amounts of personal lubricant into the vagina as per the individual requirements of each user. As well it enables the user to deliver the lubricant higher up into the fibromuscular tubular tract where it will better serve the user to address the key issue of vaginal dryness; a primary concern for post menopausal women.

It will be appreciated that the term “penile-shaped” should be interpreted loosely to include any phallus/phallic shape that also includes a generally cylindrical shape without the fine details or appearance of a penis. For example, a smooth cylinder having a diameter of 1 cm and a length of 12 cm is considered to be penile-shaped. It will also be appreciated that, for the menopausal and vaginal atrophy markets, a more discreet model not having shaft and head portions associated with a normal penis but having all the other characteristics of the present invention is provided. In this case, the penile-shape member is embodied by a generally cylindrical form with the distal end of the cylinder at least partially rounded-off.

A secondary use for this apparatus is in the adult industry (including adults films, pornography, etc), wherein this instrument will be used as a dildo for pleasure that has the added advantage of having the lubricant prefilled into the actual phallic tool which can be dispensed by the user at any time and at an desired quantity. Furthermore, due to the sometimes frequent and lengthy acts of intercourse for workers of the adult industry, a targeted delivery of a predetermined amount of lubricant is desirable and beneficial. The device is also useful in the “adult” industry for use as self stimulation in preparation for sexual activity. The unit not only dispenses lubricant to the intended area, the inner vaginal tubular tract, it does so whilst ensuring the utmost of sensuality and pleasure and intimacy due to the look and feel and manner of the dispensing unit. It will be appreciated by those skilled in the art that the device of the present invention can be exploited with its added benefits in any situation where a normal dildo would be used.

It will also be appreciated that compositions other than lubricant can be added to the lubricant in order to add additional “features” of interest, such as, for example, spermicides, bactericides, perfumes, etc.

The following is a list of various advantages provided by certain embodiments of the present invention:
Dispensing a predetermined amount of lubricant;
Having a manually controlled dispensing member allows for the user to be in control of the speed, timing and precise quantity of lubricant dispensed;
Providing an optimal length of the device allows for the lubricant to be distributed higher up into the vaginal tract where it will best offer comfort and allow for lubrication which will immediately alleviate vaginal dryness and allow for pleasurable sexual intercourse;
Designing the device and cartridge to allow for rapid cleaning of the exterior only,
Removing the need for brushes to clean out the internal delivery channel because it does not come in contact with the lubricant or the body;
Providing an easy glide sleeve inside the penile-shaped member allows for easy insertion and removal of disposable lubricant cartridges;

Most importantly, all of the above points are achieved whilst keeping and increasing the sexual pleasure of a user with the exclusive design of the penile-shaped member and dispensing member, that being a comfortable, true to form and feel, of an actual penis.

Applicants' apparatus helps administer lubricant up into the vaginal tract where it serves to better alleviate the symptoms of vaginal dryness.

Applicants describe herein a device for targeted delivery of a lubricant to a bodily orifice (e.g. vagina, anus) for lubricating the area prior to or during sexual activity (or any situation where lubrication of a body orifice is required). Many devices of different lengths are provided to ensure that delivery is properly targeted to the innermost areas of the orifice. The device has medical use for women with vaginal atrophy, a condition that is often associated with menopause and causes a significant decrease in natural lubrication, but is also useful in the “Adult” industry and homosexual community.

A longiform penile-shaped device (made of latex or silicon or any other material that possesses those advantages) having a first end for delivering the substance to the innermost area of the orifice and a second end that is configured to be actuated (pressed) for lubricant delivery through the first end.

A disposable model is envisaged where the whole device is single use and the lubricant is isolated inside the closed device. A partially reusable model is also envisaged having replaceable lubricant “cartridges”. The cartridges can be sold separately and the lubricant can be doped with various fragrances/perfumes or substances (therapeutic, spermicidal, bactericidal, fungicidal, etc) depending on whether it is used to limit fertility and/or transmission of diseases during sexual activity.

One of the major advantages of the device is that, due to the tight fit distal end of the cartridge which meets the distal end of the device (the head of the penile-shaped member), it need only be washed on the outside and not on the inside, after the cartridge is removed. Another major advantage is that the device allow for dispensing a lubricant without a mess and without having to get any lubricant on the hands.

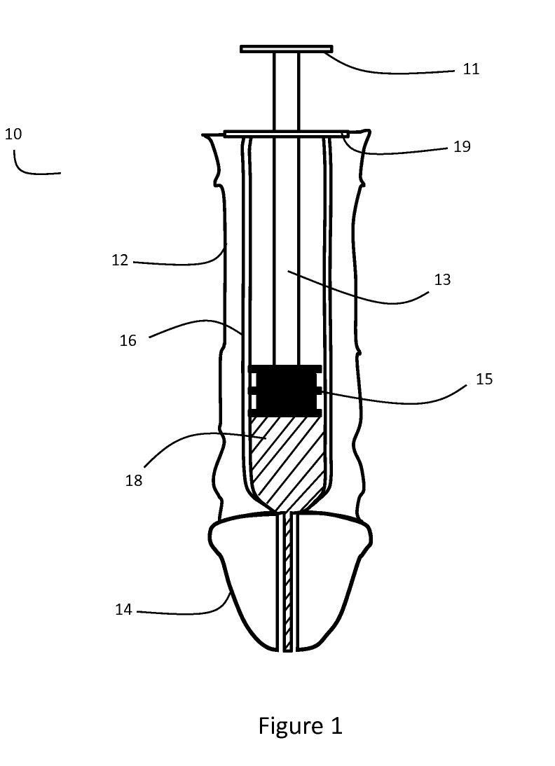

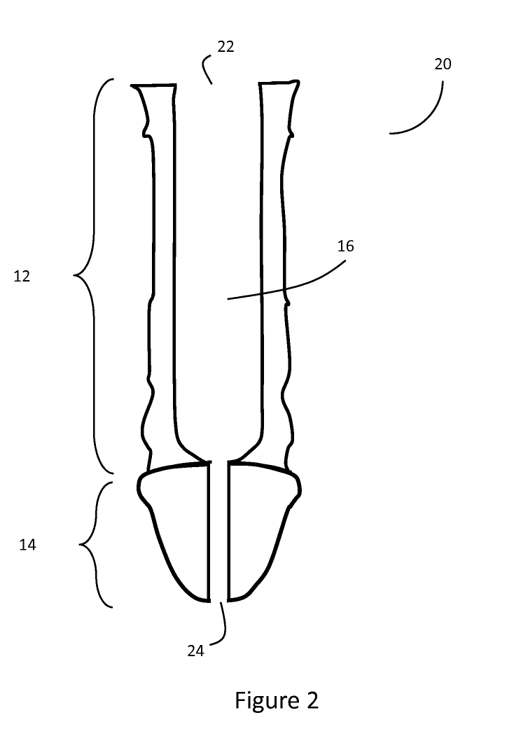

FIG. 1 shows a cross-sectional schematic representation of an embodiment of a lubricant delivery device 10 according to the present invention. The device comprises a penile-shaped member 20 (see FIG. 2) having a shaft 12 at a proximal end and a head 14 at a distal end. The penile-shaped member 20 has a conduit 16 therethrough from a proximal end to a distal end. The device also comprises a sealed cartridge containing a plunger 30 with a plunger handle 11 that allows to manipulate the plunger 30 for dispensing the lubricant 18, a plunger shaft 13 and a plunger head 15 for establishing a tight fight with a reservoir 34 portion of a cartridge 32. The cartridge 32 has a fastener 19 for fastening the cartridge 32 to the penile-shaped member 20.

FIG. 2 shows a schematic cross-sectional representation of a penile-shaped member 20 according to an embodiment of the present invention. The penile-shaped member 20 comprises a shaft 12 and a head 14. The shaft 12 has a proximal end aperture 22 at a proximal end and a distal end aperture 24 at a distal end. A conduit 16 defines a passageway from a proximal end aperture 22 to a distal end aperture 24. The conduit is wider at a proximal end then at a distal end. The penile-shaped member can advantageously be made of latex but any other material that provides the advantages found in commercial dildos can be used. For example, natural and synthetic latexes (and rubbers), such as, but not limited to styrene-butadiene rubber, acrylonitrile butadiene styrene, acrylic polymers, polyvinyl acetate, rubber.

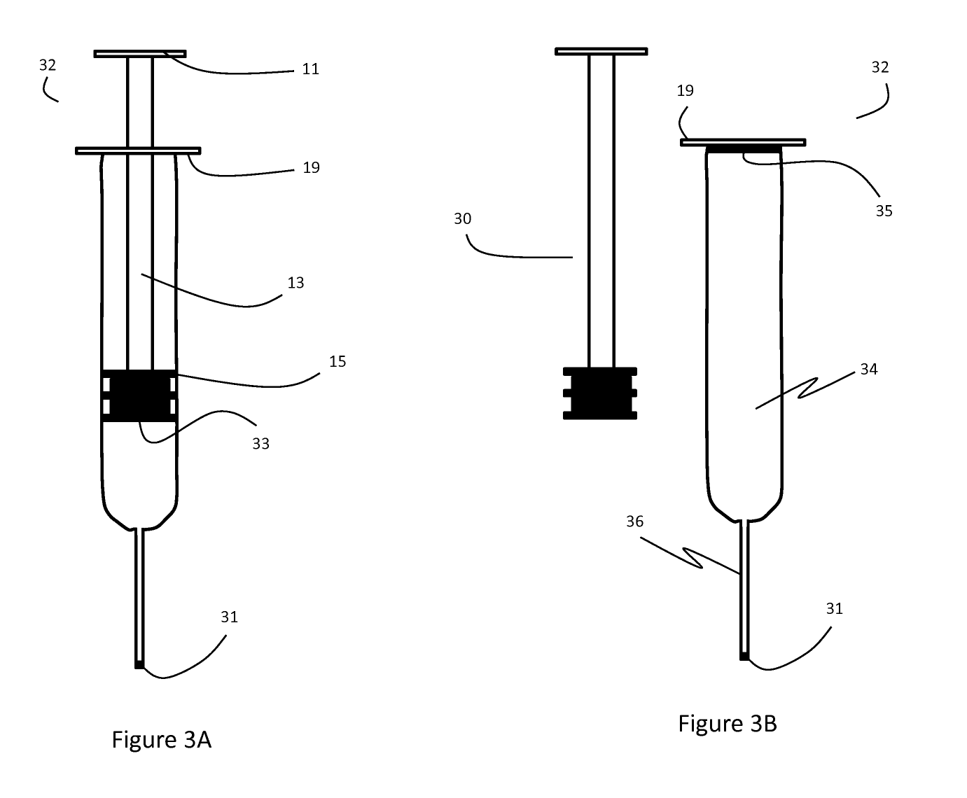

FIG. 3 shows a schematic cross-sectional representation of a cartridge 32 and a dispensing member according to an embodiment of the present invention. FIG. 3A shows that a dispensing member (plunger 30 seen in FIG. 3B) can be incorporated to the sealed cartridge 32, thus acting as a proximal end seal 33. In such an embodiment, the plunger 30 acts as a proximal end seal 33 and the blister seal 31 acts as the distal end seal for the cartridge 32. In another embodiment shown in FIG. 3B, the proximal end also comprises a proximal end blister seal 35 that may be unsealed by insertion of the plunger 30 into the reservoir 34 of cartridge 32. In one case (FIG. 3A), the cartridge comes with the plunger that acts as a seal and in another case, the plunger comes separately and the distal end is sealed by another method. In some embodiments where a plunger is used for delivery of the substance, it is advantageous to provide a plunger that does not have the appearance of a hospital syringe plunger but rather is manufactured with the latex device to make the delivery process a normal and fun part of preliminaries for example.

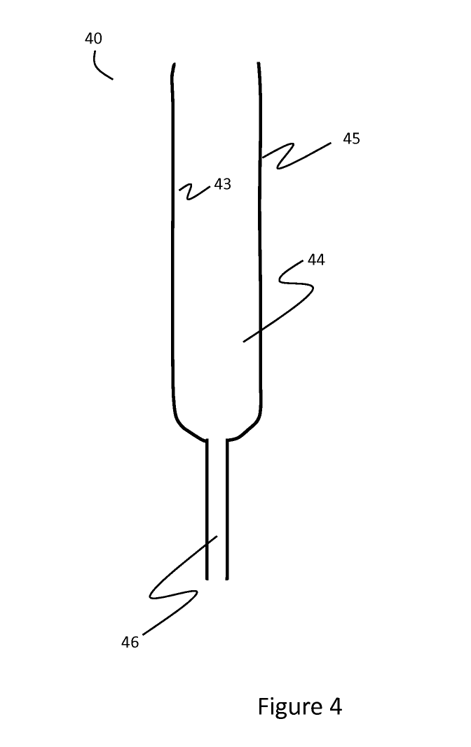

FIG. 4 shows a schematic cross-sectional representation of a sleeve 40 according to an embodiment of the present invention. The sleeve 40 comprises a reservoir portion 44 that is designed to receive the reservoir 34 of a cartridge 32. The sleeve also comprises a delivery channel portion 46 for receiving a delivery channel 36 of a cartridge 32. The sleeve 40 is generally cylindrical in shape with a wider proximal end and a narrower distal end. The sleeve 40 is designed to be inserted into and tightly mate with the penile-shaped member 20. In some embodiments, the sleeve 40 is designed with a low-friction surface on an inside surface 43 in order to facilitate receiving and removing a cartridge 32 containing lubricant 18 and a higher friction surface on an outside surface 45 as well as a tight mating with the penile-shaped member to ensure that the sleeve 40 and the penile-shaped member 20 are securely and permanently attached together. In some embodiments, the sleeve 40 and penile-shaped member 20 are designed to remain permanently attached even during the heavy duty wash cycle of a dishwasher.

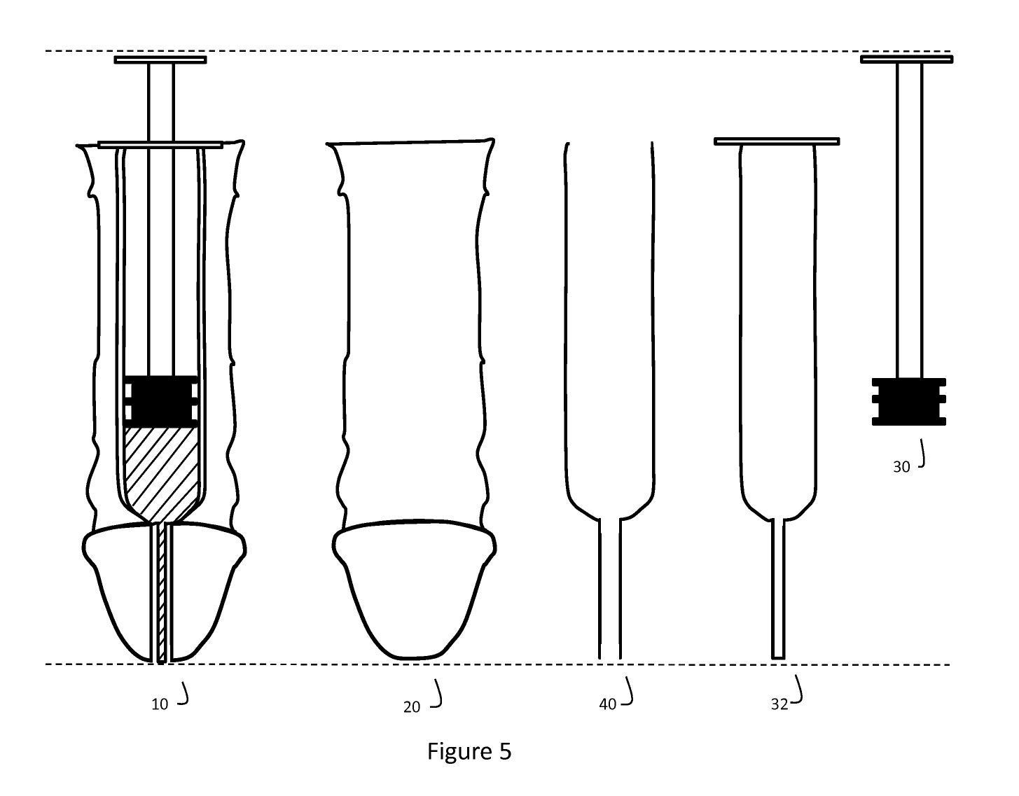

FIG. 5 shows an exploded cross-sectional view of a lubricant delivery device 10 according to an embodiment of the present invention. The device 10 comprises a penile-shaped member 20, a sleeve 40 a cartridge 32 and a dispensing member, which, in this case, is a plunger 30. It will be appreciated that, because the distal end of the cartridge 32 is designed to reach the distal end of the penile-shaped member 20, no lubricant comes in contact with the conduit 16 or sleeve 40 during delivery/dispensing of the lubricant. Furthermore, although this aspect is not clear in FIGS. 1 and 5, the outer surface of the sleeve 40 establishes a tight fit with the penile-shaped member 20 and the outer surface of the cartridge 32 establishes a tight fit with the sleeve 40, to ensure that no lubricant 18 can re-enter the conduit 16 between the sleeve 40 and the penile-shaped member 20 or between the cartridge 32 and the sleeve 40.

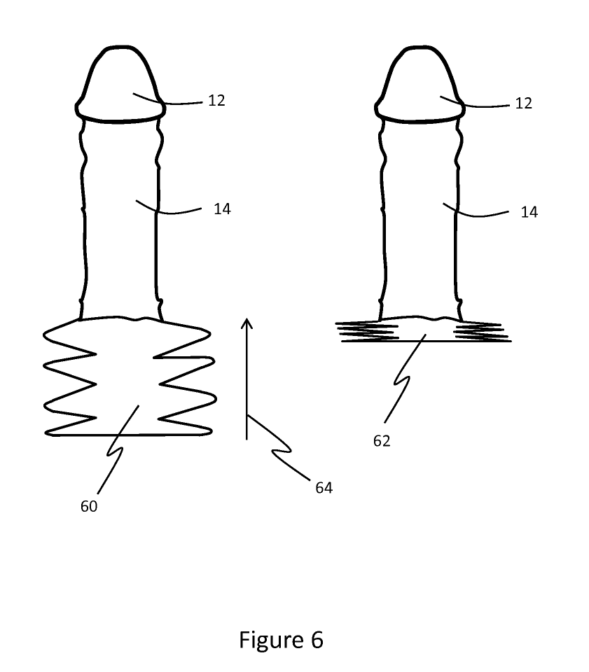

FIG. 6 shows a side view of a lubricant delivery device with an accordion dispensing member according to an embodiment of the present invention. In this embodiment, an accordion member can be attached to a penile-shaped member having a head 12 and a shaft 14 in order to dispense a lubricant 18. In this embodiment, the lubricant is located in a cartridge that is inserted into the penile-shaped member 20, after which the air-filled accordion member 60 is secured to the penile-shaped member 20. When lubricant delivery is required, the proximal end of the air-filled accordion member 60 is pushed and air located in the accordion member passes to the penile-shaped device 20 to force lubricant 18 through the distal end aperture 24. After removing at least some air from the air-filled accordion member 60, it becomes a compressed accordion member 62. In some embodiments, the accordion member can comprise the lubricant cartridge 32 as well as the air required to force out the lubricant 18 from a reservoir 44 through a delivery channel 46. Lubricant deliver according to the present embodiment occurs after a longitudinal push-dispensing 64 action.

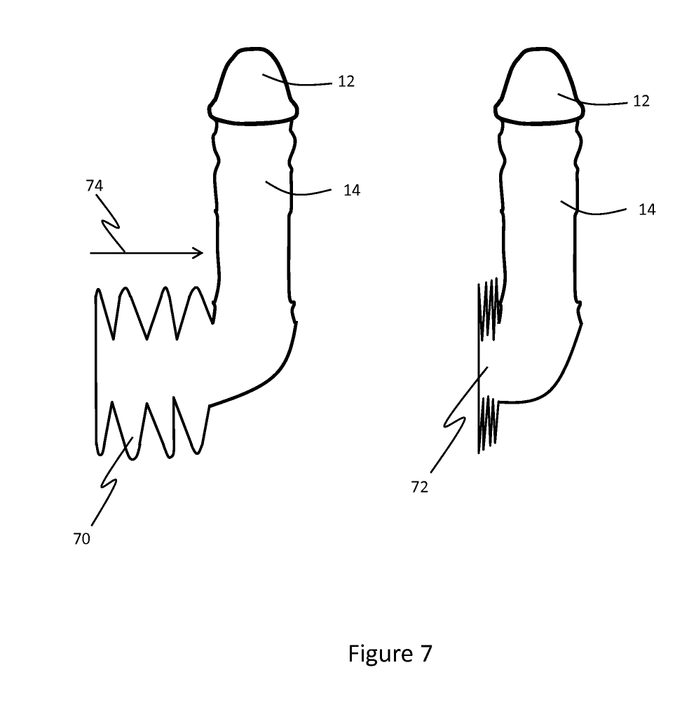

FIG. 7 shows a side view of a lubricant delivery device with an accordion dispensing member according to another embodiment of the present invention. Whereas the accordion member shown in FIG. 6 allows for a longitudinal push-dispensing 64, the accordion member of FIG. 7 allows for a lateral push-dispensing 74. During such a dispensing action, the air-filled accordion is compressed laterally rather than longitudinally.

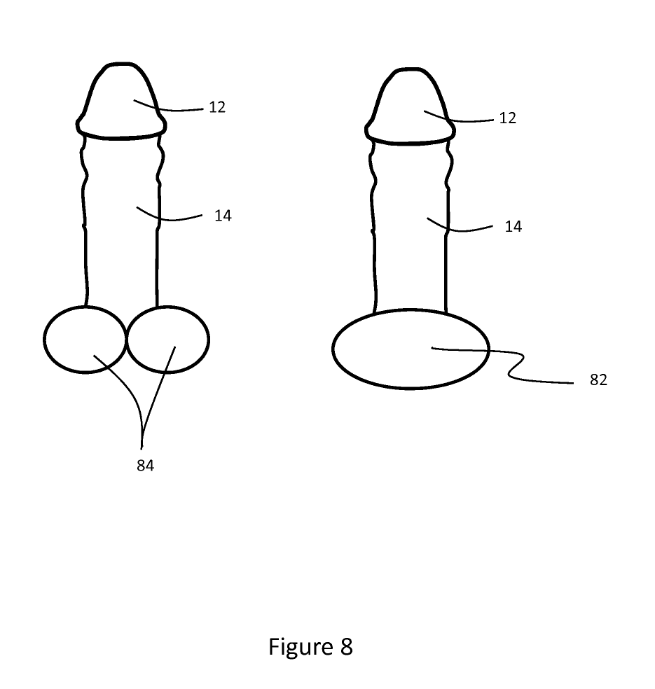

FIG. 8 shows a side view a lubricant delivery device with a dispensing member according to yet another embodiment of the present invention. With a penile-shaped member 20 comprising a scrotum-like appendage, the delivery of lubricant 18 can be actuated by “squeezing” the appendage to force out the lubricant 18. The appendage can appear more like testicles 84 or like a scrotum 82. The main objective is that the squeezable dispensing means give a more natural feel and appearance to the device.

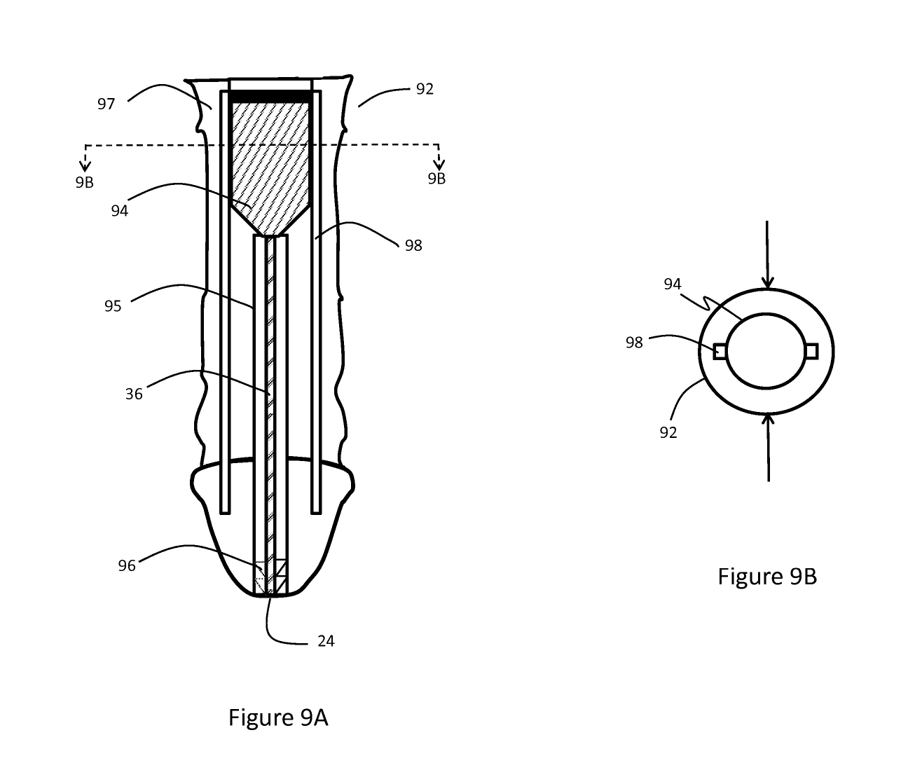

FIG. 9A shows a cross-sectional schematic representation of yet another embodiment of the present invention having a squeezable dispensing member 92 that is an integral part of the shaft portion of the device. This embodiment also provides a one-way valve 96 acting as a distal end seal 31 for sealing off the distal end aperture. In the embodiment shown in FIG. 9, the penile-shaped member is manufactured from foam latex 97. The advantages of using foam latex are two-fold. The first is that foam latex is cheaper than solid latex because, being less dense, it contains less of the more expensive material. The second is that it allows to easily squeeze the proximal shaft portion of the penile-shaped member to compress the reservoir pouch 94. Because softer latex is used, it is advantageous to provide at least two stiffening rods 98. The presence of the stiffening rods 98 provides a certain desired rigidity to the device yet allows to squeeze the proximal end from the two sides that do not have stiffening rods 98, which can be made of a hard plastic or any other material providing the desired rigidity. For example, the reservoir pouch 94 can be bag-like and very deformable while the delivery channel should be of sufficient rigidity to allow easy insertion into the conduit 16 of penile-shaped member 20. The reservoir 94 and delivery channel 36. A liner 95 that acts as a sleeve is provided inside the delivery channel 36 part of the conduit to facilitate insertion and removal of a lubricant cartridge.

FIG. 9B is a bottom cross-sectional view through the dotted line of FIG. 9A. Squeezing on the top and bottom sides (see arrows) of the penile-shaped member at the proximal end of the shaft forces lubricant down the delivery channel and expels lubricant 18 from the distal end aperture 24. The “lateral” stiffening rods 98 do not prevent this squeeze action because they are on opposite sides. The soft foam latex is stiff enough to work as a dildo, but lighter and more cost effective than a solid latex dildo.

In use, the cartridge is inserted and fastened to the penile-shaped member, the dispensing means is slightly actuated to dispense a small quantity of lubricant to allow easy insertion of the device into the target orifice, such as a vagina. Once the distal end tip of the device is properly located inside the vagina, the desired amount of lubricant can be delivered.

It will be appreciated by those skilled in the art that the lubricant-filled cartridges can be single-use (but recyclable/re-usable) cartridges or disposable cartridges. In the latter, the cartridges can be used, recycled, cleaned, sterilized, refilled with lubricant and finally sealed for re-use whereas in the former, the empty or partially empty cartridges can simply be disposed of in the trash (or recycled without re-use).

It will be appreciated that if the penile-shaped member is made of a material that naturally provides a low friction mating with the cartridge (which is not the case with latex), the sleeve 40 would be the inside surface of the conduit 16 and thus considered as an integral part of the penile-shaped member 20.

While the invention has been described in connection with specific embodiments thereof, it will be understood that it is capable of further modifications and this application is intended to cover any variations, uses, or adaptations of the invention following, in general, the principles of the invention and including such departures from the present disclosures as come within known or customary practice within the art to which the invention pertains and as may be applied to the essential features herein before set forth, and as follows in the scope of the appended claims.

1. A device for targeted delivery of a lubricant to an orifice comprising:
a penile-shaped member comprising a shaft at a proximal end and a head at a distal end, said penile-shaped member further comprising a conduit therethrough from a proximal end aperture to a distal end aperture;
a sealed cartridge containing said lubricant for removably inserting in said conduit;
wherein said distal end of said cartridge is configured to mate with said conduit at said distal end aperture to prevent said lubricant from entering said conduit during use; and
a dispensing member for delivering said lubricant to said orifice.

2. The device of claim 1, further comprising a sleeve having an outer surface configured to securely mate with said conduit and a low-friction inner surface for receiving and removing said cartridge, said sleeve comprising a reservoir portion for receiving a reservoir of said cartridge located generally in a shaft portion of said device and a delivery channel portion for receiving a delivery channel of said cartridge located generally in a head portion of said device.

3. The device of claim 1, wherein said dispensing member comprises a plunger for a longitudinal push-dispensing.

4. The device of claim 1, further comprising a fastener for fastening said cartridge to said penile-shaped member.

5. (canceled)

6. The device of claim 1, wherein said lubricant comprises K-Y® jelly.

7. (canceled)

8. The device of claim 1, wherein said lubricant further comprises one or more of a therapeutic substance and a spermicide.

9. (canceled)

10. The device of claim 1, wherein said lubricant further comprises a cosmetic substance.

11. (canceled)

12. The device of claim 1, wherein said proximal end aperture is wider than said distal end aperture.

13. The device of claim 1, wherein said cartridge is a single-use cartridge.

14. (canceled)

15. The device of claim 1, wherein the dispensing member further comprises an air-filled appendage fastened to or extending from said proximal end, and wherein an inside of said appendage is or becomes in fluid communication with said cartridge for dispensing said lubricant upon compressing said appendage.

16. The device of claim 15, wherein said appendage is configured to have a scrotum-like appearance.

17. The device of claim 1, wherein said dispensing member comprises an accordion member for one of a longitudinal and a lateral push-dispensing.

18. The device of claim 1, wherein a cartridge seal comprises one of a snap-off seal, a pull-off tab, a removable cap, a screw cap, a one-way valve and a check valve.

19. The device of claim 1, wherein penile-shaped member is essentially made of foam latex.

20. The device of claim 19, wherein said penile-shaped member further comprises two or more stiffening rods to impart a rigidity to said member.

21. The device of claim 19, wherein said dispensing member is a squeezable portion at a proximal end of said shaft.

22. The device of claim 1, wherein said penile-shaped member comprises an external texture or details a penis.

23. A device for targeted delivery of a lubricant to a body orifice comprising:
a penile-shaped member comprising a shaft at a proximal end and a head at a distal end, said penile-shaped member further comprising a conduit therethrough from a proximal end aperture to a distal end aperture;
a sleeve having an outer surface configured to securely mate with said conduit and a low-friction inner surface for receiving and removing a replaceable cartridge, said sleeve comprising a reservoir portion for receiving a reservoir of said cartridge located generally in a shaft portion of said device and a delivery channel portion for receiving a delivery channel of said cartridge located generally in a head portion of said device.

24. The device of claim 23, wherein said proximal end is configured for receiving said replaceable cartridge containing said lubricant.

25-27. (canceled)

28. A kit for targeted delivery of a lubricant to an orifice comprising:
a penile-shaped member comprising a shaft at a proximal end and a head at a distal end, said penile-shaped member further comprising a conduit therethrough from a proximal end aperture to a distal end aperture;
a sleeve having an outer surface configured to securely mate with said conduit and a low-friction inner surface for receiving and removing a replaceable cartridge, said sleeve comprising a reservoir portion located at or near said proximal end and a delivery channel located at or near said distal end;
a sealed cartridge containing said lubricant for removably inserting in said conduit;
wherein said distal end of said cartridge is configured to mate with said conduit at said distal end aperture of said conduit to prevent said lubricant from entering said conduit during use; and
a dispensing member for delivering said lubricant to said orifice.

29-31. (canceled)
